(19) United States
(12) Patent Application Publication
(10) Pub. No.: US 2016/0161044 A1
(43) Pub. Date: Jun. 9, 2016

(54) BASE FOR POWER SOURCE COMPONENTS

(71) Applicant: Caterpillar Inc., Peoria, IL (US)

(72) Inventor: Miroslav Halicek, Peachtree City, GA (US)

(73) Assignee: Caterpillar Inc., Peoria, IL (US)

(21) Appl. No.: 14/564,541

(22) Filed: Dec. 9, 2014

(51) Int. Cl. F16M 5/00; H02K 7/18; F16M 7/00

(52) U.S. Cl. CPC F16M 5/00; F16M 7/00; H02K 7/1815

(57) ABSTRACT

A base member for mounting one or more power source components is provided. The base member includes a cementitious body including an upper surface, a lower surface distal from the upper surface, and a side surface defined between the upper surface and the lower surface. The base member further includes a coupling device extending from the upper surface. The coupling device includes one or more fastening members configured to mount the one or more power source components thereon. The cementitious body is integrally formed with the coupling device. The base member further includes an isolation member disposed around the coupling device on the upper surface of the cementitious body. The isolation member is made from a vibration damping material.

### TECHNICAL FIELD

The present disclosure relates to a base for disposing power source components thereon, and more particularly to a cementitious base for disposing a generator set thereon.

### BACKGROUND

A power source, such as a generator set, is used for various applications such as telecommunication systems, hospitals and manufacturing industries. Generally, the generator set is permanently installed on a ground surface near to the respective utilities or the buildings. A typical generator set includes a metal base for supporting an engine, a generator, a control panel and other related components of the generator set thereon. The generator set is transported to an installation location and the metal base is placed on a concrete bed prepared on a ground surface of the installation location. Design and manufacturing of the metal base is complex as weight of the components and vibration generated by the engine and the generator has to be considered while designing the metal base. Thus, a significant development cost is incurred while developing the metal base for assembling the generator set. Further, the concrete bed also needs to be designed as per requirements of the generator set. Hence, the concrete bed may result in additional costs and may not have a desired specification for installation of the generator set along with the metal base.

JP Patent Number H1136331 (the '331 patent) discloses a concrete foundation for mounting an engine generator thereon. The concrete foundation includes a first foundation member made of a concrete block put in the installation site of the engine generator. The concrete foundation further includes a second foundation member made of a concrete block stacked on the first foundation member. The second foundation member includes a first set of screw holes for mounting a support member thereon. The support member is a metal body. The engine generator is mounted on the support member.

The second foundation member includes a second set of screw holes engage with the first foundation member via bolts. Manufacturing the first foundation member and the second foundation member separately may involve additional resources, such as separate molds, additional molding components for defining the screw holes and material. The '331 patent also discloses additional vibration isolation member disposed between the first and the second foundation members. Hence, cost and time of manufacturing such a concrete foundation may increase. Further, installation of the first and second foundation members in the installation site may be complex and time consuming. Further, the '331 patent also discloses an additional metal support member disposed between the generator set and the second foundation member. This may further increase manufacturing and installation cost and time.

### SUMMARY OF THE DISCLOSURE

In one aspect of the present disclosure, a base member for mounting one or more power source components is provided. The base member includes a cementitious body including an upper surface, a lower surface distal from the upper surface, and a side surface defined between the upper surface and the lower surface. The base member further includes a coupling device extending from the upper surface of the cementitious body. The coupling device includes one or more fastening members configured to mount the one or more power source components thereon. The cementitious body is integrally formed with the coupling device. Further, the base member includes an isolation member disposed around the coupling device on the upper surface of the cementitious body. The isolation member is made from a vibration damping material.

In another aspect of the present disclosure, a generator set is provided. The generator set includes an engine, a generator coupled to the engine and a control panel in electric communication with the engine and the generator. The generator set includes a base member for mounting the engine, the generator and the control panel thereon. The base member includes a cementitious body including an upper surface, a lower surface distal from the upper surface, and a side surface defined between the upper surface and the lower surface. The base member further includes a coupling device extending from the upper surface of the cementitious body. The coupling device includes one or more fastening members configured to mount the engine, the generator and the control panel thereon. The cementitious body is integrally formed with the coupling device. The base member further includes an isolation member disposed around the coupling device on the upper surface of the cementitious body. The isolation member is made from a vibration damping material.

In yet another aspect of the present disclosure, a base member for mounting one or more power source components is provided. The base member includes a cementitious body including an upper surface, a lower surface distal from the upper surface, and a side surface defined between the upper surface and the lower surface. The base member further includes a coupling device extending from the upper surface of the cementitious body. The coupling device includes one or more fastening members configured to mount the one or more power source components thereon. The cementitious body is integrally formed with the coupling device. The base member further includes an isolation member disposed around the coupling device on the upper surface of the cementitious body. The isolation member is made from a vibration damping material. The base member further includes a plurality of fastening members disposed adjacent to a periphery of the cementitious body. The plurality of fastening members is configured to mount an enclosure.

Other features and aspects of this disclosure will be apparent from the following description and the accompanying drawings.

### BRIEF DESCRIPTION OF THE DRAWINGS

FIG. 1 is a perspective view of power source components mounted on a base member, according to an embodiment of the present disclosure;

FIG. 2 is a top perspective view of the base member, according to an embodiment of the present disclosure;

FIG. 3 is a bottom perspective view of the base member, according to an embodiment of the present disclosure;

FIG. 4 is a top perspective view of the base member disposed on a ground surface, according to an embodiment of the present disclosure; and

FIG. 5 is a top perspective view of the base member, according to another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

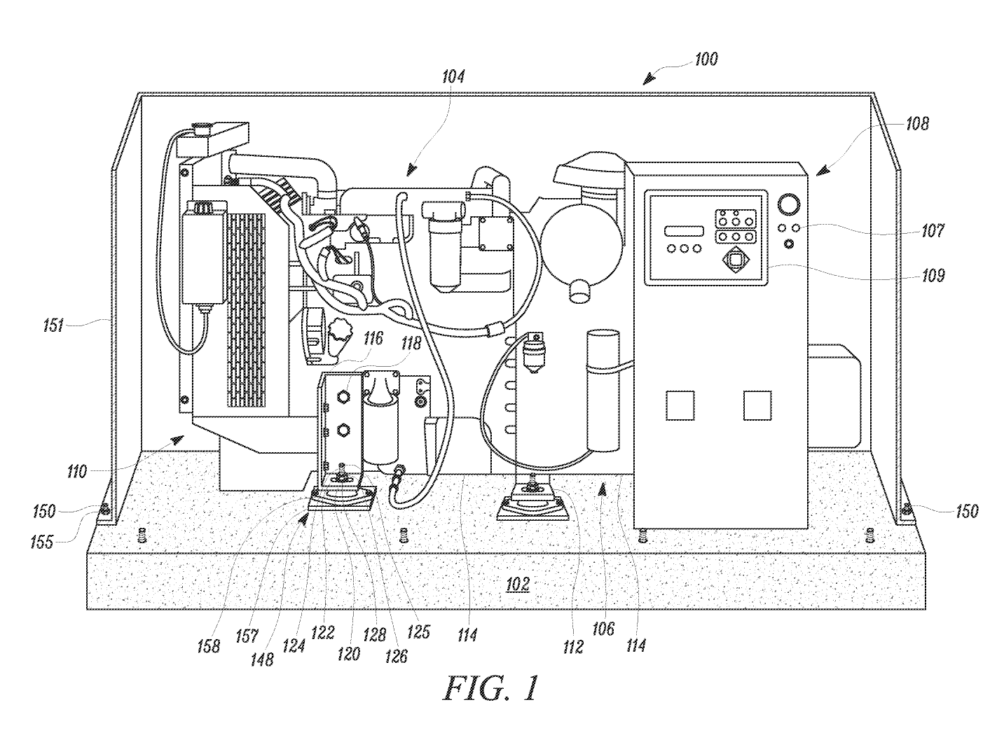

FIG. 1 illustrates a perspective view of a power source 100 mounted on a base member 102, according to an embodiment of the present disclosure. In the illustrated embodiment, the power source 100 is a generator set. In other embodiments, the power source may be an electric motor, a hydraulic pump, and the like, that are required to be installed on a ground surface. The power source 100 will be referred hereinafter as “the generator set 100”. The generator set 100 may be configured to supply electric power in locations where utility power is not available or when backup electric power is required. Specifically, in applications such as telecommunications, hospitals and data processing centers, the generator set 100 may be permanently installed on a ground surface near the respective locations.

The generator set 100 includes an engine 104 and a generator 106 coupled to the engine 104. The engine 104 may include a single cylinder or multiple cylinders. Further, the engine 104 may run on fuels such as diesel, gasoline, natural gas, propane, other known fuel sources, or a combination thereof. The engine 104 is further coupled with a radiator 110. The radiator 110 is configured to absorb heat generated by the engine 104 and dissipate the heat to atmosphere. The generator 106 may be coupled to a crankshaft or a flywheel of the engine 104 to receive rotary power therefrom. The generator 106 may further convert the rotary power into electric power. The generator 106 may be an AC generator, DC generator or any other type of electric generators known in the art.

The generator set 100 further includes a control panel 108. The control panel 108 is in electric communication with the engine 104 and the generator 106. The control panel 108 includes one or more display devices 109 for monitoring various inputs and outputs pertaining to operation of the generator set 100. The control panel 108 may also include one or more control members such as an ON-OFF switch, a voltage/current controller, an engine controller, and the like used for controlling operation of the generator set 100. Further, the control panel 108 includes one or more input and output ports 107 for connecting the control panel 108 with other external devices for monitoring and controlling various operating parameters of the generator set 100.

The generator set 100 further includes the base member 102 for mounting the engine 104, the generator 106 and the control panel 108 thereon. The radiator 110 is also disposed on the base member 102. The engine 104, the generator 106 and the control panel 108 further include one or more mounting members 112. In an embodiment, the mounting members 112 are attached to respective outer housings 114 of the engine 104 and the generator 106. The mounting members 112 are attached to the outer housings 114 via welding, mechanical fasteners, or a combination thereof. In an alternative embodiment, the mounting members 112 are integrally formed with the respective outer housings 114 of the engine 104 and the generator 106.

One of the mounting members 112 attached to the outer housing 114 of the engine 104 is described hereinafter. Referring to FIG. 1, the mounting member 112 includes a first flange 116 adapted to be attached on the outer housing 114 of the engine 104. The first flange 116 defines a plurality of holes adapted to receive fastening members 118, such as bolts. The outer housing 114 of the engine 104 may also define a plurality of holes (not shown) corresponding to the plurality of holes provided in the first flange 116 to engage with the fastening members 118. Thus, the mounting member 112 is attached to the outer housing 114 of the engine 104 by the fastening members 118. Further, the mounting member 112 includes a second flange 120 configured to be disposed on the base member 102. In an embodiment, the first flange 116 and the second flange 120 may be part of a metallic plate. The metallic plate may have a thickness required to support the engine 104 on the base member 102. The second flange 120 defines a slot 122 to receive a fastening member 124. In an embodiment, the slot 122 may have an oval shape. The fastening member 124 may be a bolt.

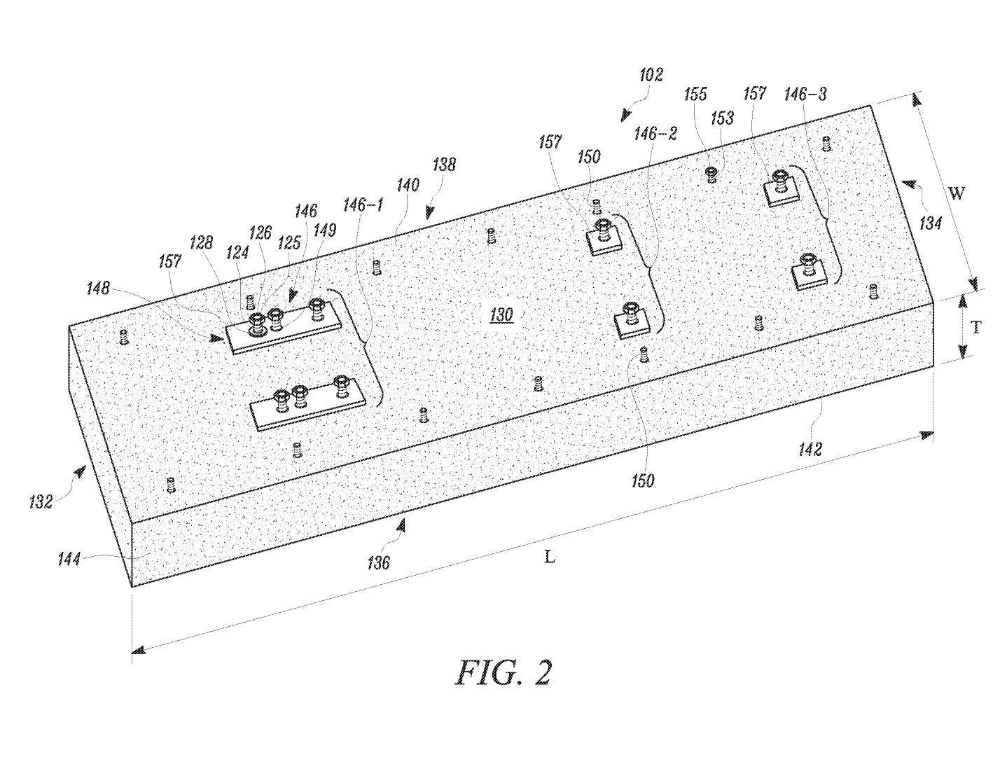

FIG. 2 illustrates a perspective view of the base member 102, according to an embodiment of the present disclosure. Reference may also be made to FIG. 1 to describe the mounting of various components of the generator set 100 on the base member 102. The base member 102 includes a cementitious body 130. The cementitious body 130 has a length ‘L’ extending between a first end 132 and a second end 134 and a width ‘W’ extending between a third end 136 and a fourth end 138. In the illustrated embodiment, the cementitious body 130 may have a rectangular shape.

The cementitious body 130 further includes an upper surface 140. Further, the upper surface 140 may be planar. The cementitious body 130 further includes a lower surface 142 distal from the upper surface 140. A thickness ‘T’ is defined between the upper surface 140 and the lower surface 142 of the cementitious body 130. The lower surface 142 may be adapted to be disposed on a ground surface. In an example, the ground surface may be a factory floor, an outdoor ground surface, and the like. The cementitious body 130 further includes a side surface 144 defined between the upper surface 140 and the lower surface 142 adjacent to the first, second, third and fourth ends 132, 134, 136, 138.

The cementitious body 130 may be made from concrete having multiple ingredients, for example, cement and aggregate. The aggregate may include sand, gravel or crushed stone. Further, water may be used during formation of concrete. The cement, aggregate and water may be mixed proportionally to produce the cementitious body 130 of a desired strength to dispose the engine 104, the generator 106 and the control panel 108 thereon. The cementitious body 130 may be also be made from a cementitious composite.

The base member 102 further includes a coupling device 146 extending from the upper surface 140 of the cementitious body 130. The coupling device 146 is configured to mount one or more components associated with the generator set 100. The coupling device 146 includes one or more fastening members 124 extending from the upper surface 140 of the cementitious body 130. The cementitious body 130 is integrally formed with the coupling device 146 to mount the engine 104 and the generator 106. In an embodiment, the coupling device 146 includes a first set of coupling devices 146-1 configured to mount the engine 104 on the upper surface 140 of the cementitious body 130. In the illustrated embodiment, the first set of coupling deices 146-1 includes two fastening members 124 spaced apart laterally corresponding to a position of the mounting members 112 of the engine 104. The first set of coupling devices 146-1 may also include one or more fastening members 124 to mount the radiator 110.

The coupling device 146 further includes a second set of coupling devices 146-2 distal from the first set of coupling devices 146-1 along the length ‘L’ of the cementitious body 130. The second set of coupling devices 146-2 is configured to mount the generator 106 on the upper surface 140 of the cementitious body 130. In the illustrated embodiment, the second set of coupling devices 146-2 includes two fastening members 124 spaced apart laterally corresponding to a position of the mounting members 112 of the generator 106.

The coupling device 146 further includes a third set of coupling devices 146-3 distal from the second set of coupling devices 146-2 along the length ‘L’ of the cementitious body 130. The third set of coupling devices 146-3 is configured to mount the control panel 108 on the upper surface 140 of the cementitious body 130. In the illustrated embodiment, the third set of coupling device 146-3 includes two fastening members 124 spaced apart laterally corresponding to a position of a mounting location (not shown) of the control panel 108.

The fastening members 124 are extending vertically from the upper surface 140, and configured to be received through the slots 122 of the respective mounting members 112 while disposing the engine 104, the generator 106, the control panel 108 and the radiator 110 on the upper surface 140 of the cementitious body 130. Each of the fastening members 124 includes a shank 125 extending vertically from the upper surface 140. The shank 125 may have a length substantially larger than a thickness of the second flange 120 of the mounting member 112. The shank 125 may include threads on an outer surface thereof.

The coupling device 146 further includes a nut 126 configured to engage with the shank 125 of the fastening members 124. The coupling device 146 further includes a washer 128. In FIG. 2, only one of the first set of coupling devices 146-1 is shown with the washer 128 for illustration. Referring to FIG. 1, in a disposed position of the engine 104 on the base member 102, the shank 125 of the fastening member 124 is received through the slot 122 of the mounting member 112. Further, the washer 128 is inserted over the fastening member 124. The nut 126 is further engaged with the fastening member 124 and tightened by a tool such as torque wrench or a spanner. In other embodiments, the fastening members 124 may be engaged with a clamp or a lock known in the art to tightly mount the engine 104, the generator 106 and the control panel 108 of the generator set 100.

The base member 102 further includes an isolation member 148 disposed around the coupling device 146 on the upper surface 140 of the cementitious body 130. The isolation member is configured to dampen vibrations generated by the engine 104 and the generator 106 during operation thereof. In an embodiment, the isolation member 148 includes a mounting pad 157. The mounting pad 157 may be made from a vibration damping material. Further, the mounting pad 157 may be in the form of a sheet having a desired thickness. The desired thickness and/or the type of vibration damping material may be selected based on various parameters including, but not limited to, weight of the power source components 100 and magnitude of vibrations generated by the engine 104 and the generator 106. The vibration damping material may be selected from a metallic damping materials such as shape-memory alloys and ferromagnetic alloys, polymeric damping materials such as rubber and polyurethane or a combination thereof. In the various embodiments, one or more such mounting pads 157 may be formed from such vibration damping materials in square, rectangular, circular, polygonal and elliptical or any other shape. Further, one or more holes 149 are formed in each of the mounting pads 157 to receive the respective fastening members 124. Further, the mounting pad 157 is disposed on the upper surface 140 of the cementitious body 130 around each of the coupling devices 146. In an embodiment, an adhesive may be used to fix the mounting pad 157 on the upper surface 140 of the cementitious body 130.

In another embodiment, one or more seismic isolators 158 are provided on upper surface 140 of the cementitious body 130 in order to absorb vibrations generated by the engine 104 and the generator 106 during operation thereof. The coupling device 146 may include a plurality of fastening members configured to receive the one or more seismic isolators 158. The seismic isolators 158 are configured to be disposed between the mounting members 112 of the power source components (for example, the engine 104 and the generator 106) and the upper surface 140 of the cementitious body 130. In an exemplary embodiment, the seismic isolator 158 may include a hole adapted to receive a bolt to couple with the mounting members 112 of the power source components. The seismic isolator 158 may include one or more resilient members (e.g., springs) configured to absorb vibrations from the engine 104 and the generator 106.

In a further embodiment, the mounting pad 157 may include additional holes (not shown) configured to receive fastening members in order to be coupled to the cementitious body 130. The seismic isolators 158 may be additionally disposed on a surface of the mounting pad 157 and attached with the cementitious body 130 via the plurality of fastening members. The engine 104 and the generator 106 may be further disposed on the seismic isolators 158. The bolts may be further inserted through the mounting members 112 of the engine 104 and the generator 106 to engage with the hole provided in the seismic isolators 158.

In a mounted position of the generator set 100 on the base member 102, the isolation members 148 are positioned between the upper surface 140 of the cementitious body 130 and the mounting members 112 of the engine 104, the generator 106 and the control panel 108. Hence, during operation of the engine 104 and the generator 106, the isolation member 148 may absorb the vibrations generated by the engine 104 and the generator 106 such that the vibration may not be transferred to the base member 102.

Referring to FIGS. 1 and 2, the base member 102 further includes a plurality of fastening members 150 disposed adjacent to a periphery of the cementitious body 130. The plurality of fastening members 150 is configured to mount an enclosure 151. A portion of the enclosure 151 is shown in FIG. 1. The enclosure 151 may be a structural member configured to surround the engine 104, the generator 106, the control panel 108, the radiator 110 and other power source components mounted on the upper surface 140 of the cementitious body 130. Further, the enclosure 151 may include one or more access doors (not shown) for servicing of the generator set 100. The enclosure 151 may protect the generator set 100 from foreign substances, such as moisture and dust.

In an embodiment, the fastening members 150 are disposed vertically on the upper surface 140 adjacent to the side surfaces 144 defined at the first end 132, the second end 134, the third end 136 and the fourth end 138 of the cementitious body 130. Each of the fastening members 150 includes a shank 153 extending vertically from the upper surface 140 of the cementitious body 130. Threads may be defined on an outer surface of the shank 153. Further, a nut 155 is engaged with the fastening members 150. In FIG. 2, only one of the fastening members 150 is shown with the nut 155 for illustration. The cementitious body 130 is integrally formed with the fastening members 150. In another embodiment, the fastening members 150 may be disposed on the side surface 144 of the cementitious body 130. Referring to FIG. 1, in a disposed position of the enclosure 151 on the base member 102, the shank 153 of each of the fastening members 150 is received through a slot (not shown) provided on the enclosure 151. Further, the nut 155 may be engaged with the fastening member 150. In other embodiments, a plurality of holes may be provided on the upper surface 140. The holes may be configured to receive a fastening member for mounting the enclosure 151 thereon.

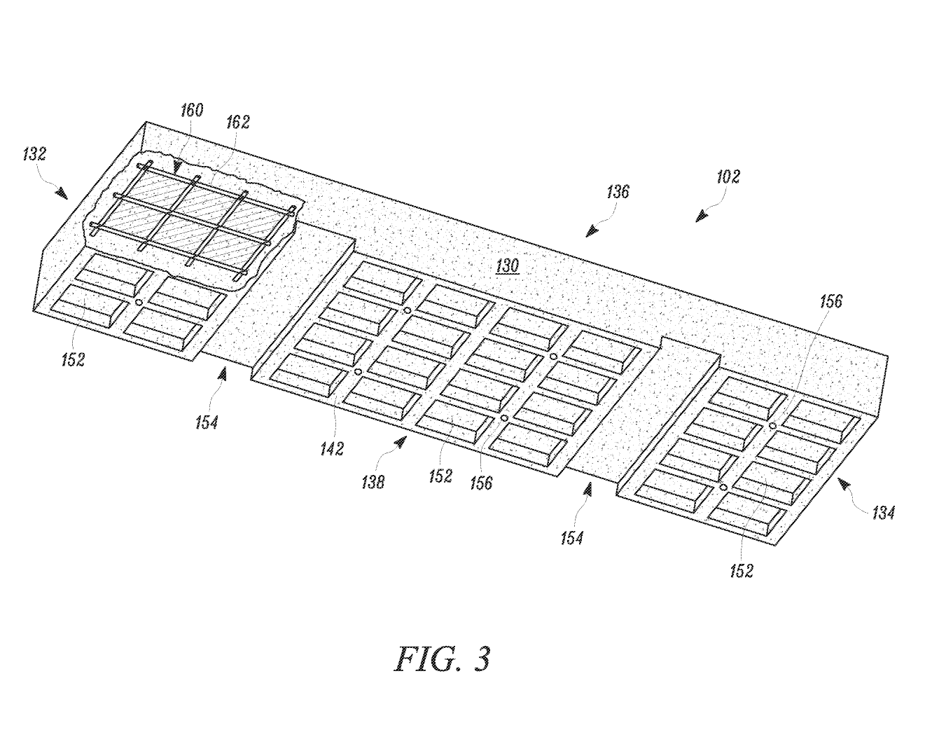

FIG. 3 illustrates a bottom perspective view of the base member 102, according to an embodiment of the present disclosure. The base member 102 includes one or more pockets 152 defined on the lower surface 142 of the cementitious body 130. In the illustrated embodiment, a plurality of pockets 152 is defined on the lower surface 142. The pockets 152 may be arranged in multiple rows on the lower surface 142. However, the pockets 152 may be arranged in any pattern on the lower surface 142.

The base member 102 further includes one or more channels 154 formed on the lower surface 142 of the cementitious body 130. The one or more channels 154 may be configured to receive an arm of a transporting machine. In an embodiment, the base member 102 includes a pair of channels 154 formed on the lower surface 142. Each of the channels 154 extends between the side surfaces 144 defined at the third end 136 and the fourth end 138 of the cementitious body 130. Further, each of the channels 154 is spaced apart along the length ‘L’ of the base member 102 corresponding to a position of a pair of lifting arms of the transporting machine, such as a fork lift. In another embodiment, the channels 154 may also extend through one of the side surfaces 144.

The lower surface 142 further includes one or more holes 156 to engage the base member 102 with a surface during transportation. In an embodiment, the one or more holes 156 may be configured to receive fastening members (not shown). The fastening members may include a bolt and a nut. The fastening members may be coupled to a mounting device fixed on the surface. The surface may correspond to a floor of a container or a cargo compartment of a shipping vehicle. In other embodiments, the fastening members may be any type of clamping device known in the art configured to attach the base member 102 with the surface of the shipping vehicle.

As shown in FIG. 3, the cementitious body 130 is integrally formed with a mesh 160. The mesh 160 includes a plurality of metallic rods 162. Each of the metallic rods 162 is coupled together to define the mesh 160. The mesh 160 may be configured to reinforce the base member 102. In an embodiment, some of the plurality of metallic rods 162 extend along the length ‘L’ of the base member 102 and remaining metallic rods 162 extend along the width ‘W’ of the base member 102 to form the mesh 160. The metallic rods 162 may be tied together by metallic threads. In further embodiments, the cementitious body 130 may be integrally formed with more than one such mesh 160 one above another to provide desired strength to the base member 102.

A method of manufacture of the base member 102 is described hereinafter, according to an exemplary embodiment of the present disclosure. A mold (not shown) may be developed from materials such as wood, a metal or a combination thereof. The mold may define a hollow chamber having a length, a width and a thickness corresponding to the length ‘L’, the width ‘W’ and the thickness ‘T’ of the cementitious body 130. The mold may be kept on a work surface convenient for operators to work with the mold. A bottom surface of the hollow chamber may include wooden or metal components complementary to a shape of the plurality of holes 156, the channels 154 and the pockets 152 described above. Further, one or more meshes 160 may be disposed within the hollow chamber. The meshes 160 may be coupled with the mold to retain a position thereof within the hollow chamber while pouring concrete material to the mold. Further, an alignment device (not shown) may be used for holding the coupling devices 146 at the desired locations as per the positions of mounting members 112 of the engine 104, the generator 106 and the mounting location of the control panel 108 of the generator set 100 intended to be mounted on the base member 102. The alignment device may also hold the fastening members 150 used to mount the enclosure 151 on the base member 102. In one embodiment, the cementitious body 130 may be integrally formed with the alignment device. In another embodiment, the alignment device may be located outside the mold. The connections between the alignment device and the coupling devices 146 may also be located outside the mold. The concrete material may be then poured into the mold to fill the hollow chamber.

The concrete material may be made by mixing two or more ingredients such as cement, supplementary cementitious materials, water, fine aggregate, coarse aggregate with or without admixtures, reinforcement, fibers and pigments. The ingredients may be mixed proportionally to produce the cementitious body 130 of a desired strength. One or more cementitious materials, such as fly ash, ground granulated blast furnace slag (GGBS), limestone fines and silica fume may be used as a binder for the concrete material. The operator may ensure that the concrete material occupies the entire space within the hollow chamber. The poured concrete material may be then allowed to cure for a time period. After the time period, the concrete material may harden to form the base member 102 of the present disclosure for mounting the generator set 100 thereon.

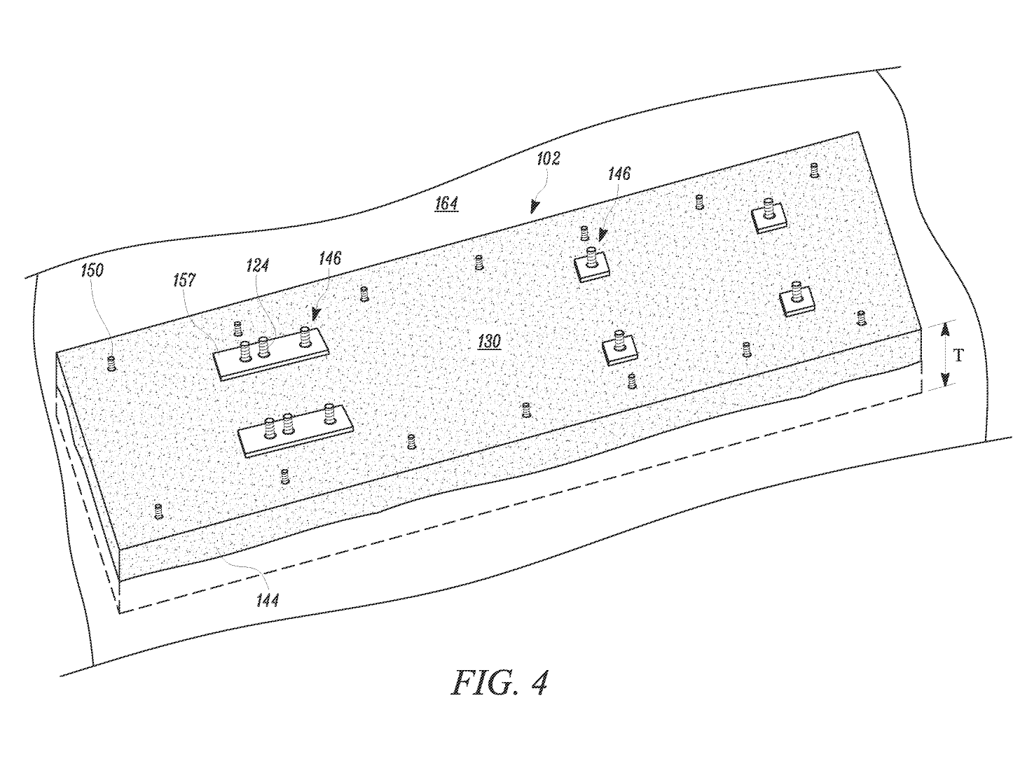

FIG. 4 shows a top perspective view of the base member 102 disposed on a ground surface 164, according to an embodiment of the present disclosure. In a disposed position of the base member 102, the side surface 144 of the cementitious body 130 is partly disposed below the ground surface 164. Specifically, a portion of the thickness ‘T’ of the side surface 144 is disposed under the ground surface 164. The other portion of the thickness ‘T’ of the side surface 144 projects outside the ground surface 164.

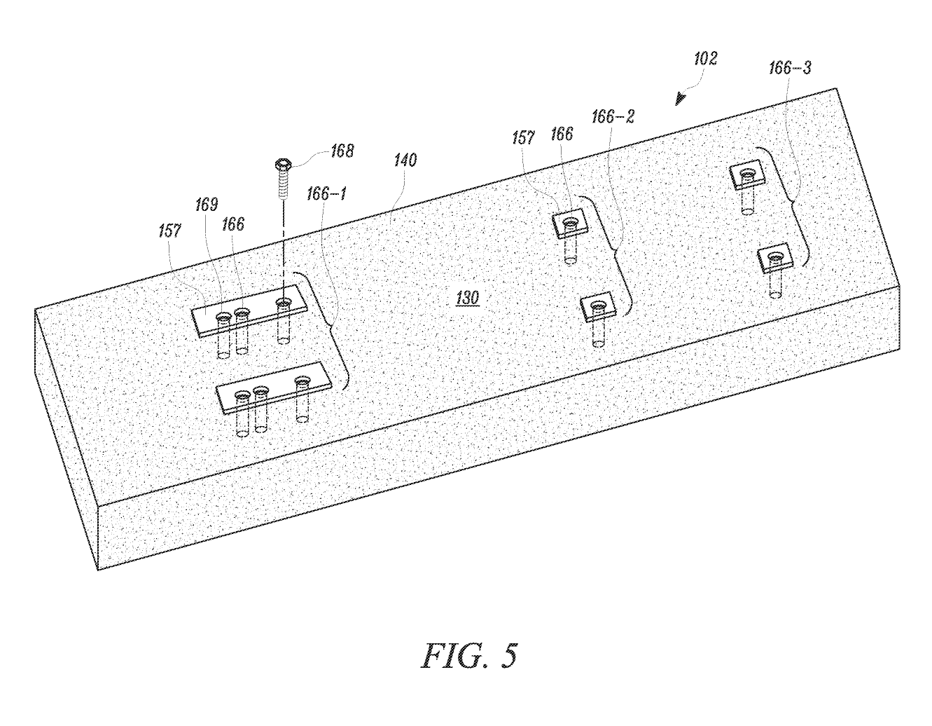

FIG. 5 illustrates a top perspective view of the base member 102, according to another embodiment of the present disclosure. A plurality of holes 166 is formed on the upper surface 140 of the base member 102. The plurality of holes 166 is configured to mount one or more components of the generator set 100. Each of the plurality of holes 166 is further configured to receive a fastening member 168 to mount the generator set 100. The fastening member 168 may be a bolt. In an embodiment, a first set of holes 166-1 is configured to mount the engine 104 and the radiator 110 on the upper surface 140 of the cementitious body 130. Further, a second set of holes 166-2 distal from the first set of holes 166-1, along the length ‘L’ of the cementitious body 130, is configured to mount the generator 106 on the upper surface 140 of the cementitious body 130. Further, a third set of holes 166-3 distal from the second set of holes 166-2, along the length ‘L’ of the cementitious body 130, is configured to mount the control panel 108 on the upper surface 140 of the cementitious body 130. A nut (not shown) may be disposed within each of the holes 166 to engage with the corresponding fastening member 168. The isolation member 148 is disposed around each of the holes 166 on the upper surface 140 of the cementitious body 130. The isolation member 148 includes one or more holes 169 aligned with the corresponding holes 166. In other embodiments, an adhesive may be used to fix the isolation member 148 with the upper surface 140 of the cementitious body 130.

### INDUSTRIAL APPLICABILITY

The present disclosure relates to the base member 102 for mounting the generator set 100 thereon. The base member 102 of the present disclosure is made from a concrete material in a factory setting, where the generator set 100 is assembled. The base member 102 is used as a replacement for a metal base that is typically used for mounting the generator set 100. During assembly of the generator set 100, the engine 104, the radiator 110, the generator 106, the control panel 108 and the enclosure 151 are mounted on the base member 102 and coupled with the respective coupling devices 146 and the fastening members 150. As the fastening members 124 of the coupling devices 146 are integrated with the base member 102 and vertically extend from the upper surface 140, the engine 104, the radiator 110, the generator 106, the control panel 108 and the enclosure 151 are quickly and easily mounted on the upper surface 140. Thus, the generator set 100 is assembled as a complete package and may be directly installed at a desired location without requiring any additional construction in the desired location. Referring to FIG. 4, the portion of the side surface 144 of the base member 102 is disposed under the ground surface 164. This may facilitate a customer to directly install the generator set 100 on a ground without much ground work, such as preparing a separate concrete bed. Hence, installation cost and time may be reduced. Further, design of the base member 102 may be customized as per specification of the generator set 100.

Further, various components of the base member 102, such as the coupling devices 146, the fastening members 150 and the isolation members 148 may be selected based on various parameters including, but not limited to, weight/dimensions of the engine 104 and the generator 106, and magnitude of vibrations generated by the engine 104 and the generator 106. Moreover, the isolation members 148 may be a localized vibration damping material developed a lower cost as compared to a metal base which has to support the whole generator set 100.

Further, the pockets 152 formed on the lower surface 142 of the base member 102 may reduce weight of the base member 102. Also, more such pockets 152 may be formed on the side surface 144 and the upper surface 140 depending on availability of space without affecting the strength of the base member 102 and mounting of the generator set 100. Design of the channels 154 may be changed based on dimensions of lifting arms of a transporting machine, such as a forklift. The plurality of holes 156 provided on the lower surface 142 may help the base member 102 to be attached with a floor of a shipping container. Thus, movement of the base member 102 during transportation may be substantially prevented.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A base member for mounting one or more power source components thereon, the base member comprising:
a cementitious body comprising:
an upper surface;
a lower surface distal from the upper surface; and
a side surface defined between the upper surface and the lower surface;
a coupling device extending from the upper surface of the cementitious body, the coupling device comprising one or more fastening members configured to mount the one or more power source components thereon, wherein the cementitious body is integrally formed with the coupling device; and
an isolation member disposed around the coupling device on the upper surface of the cementitious body, wherein the isolation member is configured to dampen vibrations generated by the one or more power source components during operation thereof.

2. The base member of claim 1, wherein the power source components comprising an engine, a generator coupled to the engine, a control panel in electric communication with the engine and the generator, and wherein the coupling device comprising:
a first set of coupling devices configured to mount the engine on the upper surface of the cementitious body;
a second set of coupling devices distal from the first set of coupling devices along a length of the cementitious body, wherein the second set of coupling devices is configured to mount the generator on the upper surface of the cementitious body; and
a third set of coupling devices distal from the second set of coupling devices along the length of the cementitious body, wherein the third set of coupling devices is configured to mount the control panel on the upper surface of the cementitious body.

3. The base member of claim 1, further comprising a plurality of fastening members disposed adjacent to a periphery of the cementitious body, wherein the plurality of fastening members is configured to mount an enclosure.

4. The base member of claim 1, further comprising one or more pockets defined on the lower surface of the cementitious body of the base member.

5. The base member of claim 4, wherein the lower surface comprises one or more holes defined between adjacent pockets to engage the base member with a surface during transportation.

6. The base member of claim 1, further comprising one or more channels formed on the lower surface.

7. The base member of claim 1, wherein the cementitious body is integrally formed with a mesh comprising metallic rods, wherein the mesh is configured to reinforce the base member.

8. A generator set comprising:
an engine;
a generator coupled to the engine;
a control panel in electric communication with the engine and the generator; and
a base member for mounting the engine, the generator and the control panel thereon, the base member comprising:
a cementitious body comprising:
an upper surface;
a lower surface distal from the upper surface; and
a side surface defined between the upper surface and the lower surface;
a coupling device extending from the upper surface of the cementitious body, the coupling device comprising one or more fastening members configured to mount the engine, the generator and the control panel thereon, wherein the cementitious body is integrally formed with the coupling device; and
an isolation member disposed around the coupling device on the upper surface of cementitious body, wherein the isolation member is configured to dampen vibrations generated by the engine and the generator during operation thereof.

9. The generator set of claim 8, wherein the coupling device comprising:
a first set of coupling devices configured to mount the engine on the upper surface of the cementitious body;
a second set of coupling devices distal from the first set of coupling devices along a length of the cementitious body, wherein the second set of coupling devices is configured to mount the generator on the upper surface of the cementitious body; and
a third set of coupling devices distal from the second set of coupling devices along the length of the cementitious body, wherein the third set of coupling devices is configured to mount the control panel on the upper surface of the cementitious body.

10. The generator set of claim 8, further comprising a plurality of fastening members disposed adjacent to a periphery of the cementitious body, wherein the plurality of fastening members is configured to mount an enclosure.

11. The generator set of claim 8, further comprising one or more pockets defined on the lower surface of the cementitious body of the base member.

12. The generator set of claim 11, wherein the lower surface comprises one or more holes defined between adjacent pockets to engage the base member with a surface during transportation.

13. The generator set of claim 8, further comprising one or more channels formed on the lower surface.

14. The generator set of claim 8, wherein the cementitious body is integrally formed with a mesh comprising metallic rods, wherein the mesh is configured to reinforce the base member.

15. A base member for mounting one or more power source components thereon, the base member comprising:
a cementitious body comprising:
an upper surface;
a lower surface distal to the upper surface; and
a side surface defined between the upper surface and the lower surface;
a coupling device extending from the upper surface of the cementitious body, the coupling device comprising one or more fastening members configured to mount the one or more power source components thereon, wherein the cementitious body is integrally formed with the coupling device;
an isolation member disposed around the coupling device on the upper surface of cementitious body, wherein the isolation member is configured to dampen vibrations generated by the one or more power source components during operation thereof; and
a plurality of fastening members disposed adjacent to a periphery of the cementitious body, wherein the plurality of fastening members is configured to mount an enclosure.

16. The base member of claim 15, wherein the power source components comprising an engine, a generator coupled to the engine, a control panel in electric communication with the engine and the generator, and wherein the coupling device comprising:
a first set of coupling devices configured to mount the engine on the upper surface of the cementitious body;
a second set of coupling devices distal from the first set of coupling devices along a length of the cementitious body, wherein the second set of coupling devices is configured to mount the generator on the upper surface of the cementitious body; and
a third set of coupling devices distal from the second set of coupling devices along the length of the cementitious body, wherein the third set of coupling devices is configured to mount the control pane on the upper surface of the cementitious body.

17. The base member of claim 15, further comprising one or more pockets defined on the lower surface of the cementitious body of the base member.

18. The base member of claim 17, wherein the lower surface comprises one or more holes defined between adjacent pockets to engage the base member with a surface during transportation.

19. The base member of claim 15, further comprising one or more channels formed on the lower surface.

20. The base member of claim 15, wherein the cementitious body is integrally formed with a mesh comprising metallic rods, the metallic rods are configured to reinforce the base member.
